(19) United States
(12) Patent Application Publication
(10) Pub. No.: US 2013/0103455 A1
(43) Pub. Date: Apr. 25, 2013

(54) SYSTEMS AND METHODS FOR DETERMINING AND INCREASING BUSINESS ACTIVITY

(71) Applicants: Kevin Bernhard Falk, Vancouver (CA); Robert Edward Alexander, Coquitlam (CA); Ryan Walter Volberg, Anmore (CA)

(72) Inventors: Kevin Bernhard Falk, Vancouver (CA); Robert Edward Alexander, Coquitlam (CA); Ryan Walter Volberg, Anmore (CA)

(73) Assignee: VIVONET, INC., Burnaby (CA)

(21) Appl. No.: 13/445,135

(22) Filed: Apr. 12, 2012

Related U.S. Application Data
(60) Provisional application No. 61/477,574, filed on Apr. 20, 2011.

(51) Int. Cl. G06Q 30/02

(52) U.S. Cl. CPC G06Q 30/0264
USPC 705/7.29; 705/14.61; 705/14.15

(57) ABSTRACT

Systems and methods for determining relative business volume for a given time frame between a specific retail establishment and other comparable retail establishments. A database storing retail transactions for multiple retail establishments is accessed for data relating to retail transactions for a specific retail establishment. These transactions are for a specific time period in question. Retail transactions for other retail establishments that are comparable to the specific retail establishment are also retrieved for the same time period. These transactions for the other establishments are then aggregated to render the data anonymous. The aggregated data is then processed on a per-retail establishment basis and compared to the data for the specific retail establishment. If the specific retail establishment is considered to have lower business transactions than the other establishments, the data retrieved is then analyzed and promotional events designed to increase business for the specific retail establishment are then recommended.

### RELATED APPLICATIONS

This application claims priority on U.S. Patent Application Ser. No. 61/477,574 filed Apr. 20, 2011, which is incorporated herein by reference.

### TECHNICAL FIELD

The present invention relates to software for use in developing business opportunities and, more specifically, relates to software which can determine if a business establishment is in a slow period and which can recommend measures to counteract the slow period.

### BACKGROUND OF THE INVENTION

Businesses, and especially retail establishments, are subject to the so-called business cycle. Depending on the items or services being sold at the retail establishment, the business cycle may follow the seasons, it may follow the school year, or it may be subject to other factors which may not be readily apparent or documented.

While some businesses will be privy to their own business cycle, others may not be. As well, even during boom times in the business cycle of a retail establishment, there may be times for business may be considered “slow” relative to other similar businesses. For these retail establishments, such “slow” times may not be readily apparent as, while business may be steady, that business may be lower and slower relative to other similar establishments. As an example, in terms of business volume, coffee shop A may have $5,000 worth of coffee and doughnut sales on a given day. To the business owner of coffee shop A, that may be a healthy volume. However, if coffee shops B, C, and D (which are of comparable size and product and service offering to coffee shop A) each have an average of $7,500-$8,000 of sales for the same day, then coffee shop A is clearly “slow” relative to the other coffee shops. Of course, the owner of coffee shop A would not know of this and may be thinking that his retail establishment is doing fine when, in reality, he may be losing business to the other shops.

However, knowing when business is “slow” is only half of the equation. If a retail establishment is alerted to the fact that they are doing relatively worse than their similar competitors in terms of business volume, most retail establishments would need some way to compensate for such “slowness”. Unfortunately, most businesses would, faced with such data, panic and launch ill-conceived and ill-prepared promotional campaigns. Such campaigns, while probably designed to bring in customers, will not have their impact felt and analyzed for weeks if not months after the campaigns have started.

There is therefore a need for systems and methods which would be able to determine whether a retail establishment is doing worse relative to other similar retail establishments. Also needed would be some system, method, or means for recommending events which would serve to counteract the relative difference between the retail volumes of different but comparable retail establishments.

### SUMMARY OF INVENTION

The present invention relates to systems and methods for determining relative business volume for a given time frame between a specific retail establishment and other comparable retail establishments. A database storing retail transactions for multiple retail establishments is accessed for data relating to retail transactions for a specific retail establishment. These transactions are for a specific time period in question. Retail transactions for other retail establishments that are comparable to the specific retail establishment are also retrieved for the same time period. These transactions for the other establishments are then aggregated to render the data anonymous. The aggregated data is then processed on a per-retail establishment basis and compared to the data for the specific retail establishment. If the specific retail establishment is considered to have lower business transactions than the other establishments, the data retrieved is then analyzed and promotional events designed to increase business for the specific retail establishment are then recommended.

In a first aspect, the present invention provides a method for determining a level of business activity for a specific retail establishment, the method comprising:
a) determining a time frame for determining said level of business activity;
b) retrieving business transactions for said specific retail establishment from a database for said time frame;
c) determining other retail establishments which are in a similar type of business as said specific retail establishment;
d) retrieving business transactions for said other retail establishments from said database for said time frame;
e) determining a retail establishment total for said business transactions retrieved in step b);
f) determining an other business total for said business transactions retrieved in step d), said other business total being determined on a per retail establishment basis;
g) determining if said retail establishment total determined in step b) is higher or lower than said other business total determined in step f);
h) in the event said retail establishment total determined in step b) is lower than said other business total determined in step f), determining if said retail establishment total is within a predetermined percentage of said other business total;
i) in the event said retail establishment total is lower than said other business total and said retail establishment total is not within a predetermined percentage of said other business total, generating an alert to a user.

In a second aspect, the present invention provides a method for determining promotional offers for increasing business activity for a specific retail establishment, the method comprising:
a) retrieving data from a database relating to sales made by said specific retail establishment for a predetermined time period;
b) determining which key items or services sold by said specific retail establishment are most likely to appeal to consumers for a given time frame;
c) sending a recommendation to a representative of said specific retail establishment for a promotional event involving said key items or services.

In a third aspect, the present invention provides a method for determining promotional offers for increasing business activity for a specific retail establishment, the method comprising:
a) retrieving data from said database relating to sales made by said other retail establishments for a predetermined time period;
b) determining which key items or services sold by said other retail establishment are most likely to appeal to consumers for a given time frame;
c) sending a recommendation to a representative of said specific retail establishment for a promotional event involving said key items or services.

In a further aspect, the present invention provides a method for determining promotional offers for increasing business activity for a specific retail establishment, the method comprising:
a) retrieving data from said database relating to sales made by at least one retail establishment for a predetermined time period;
b) determining which key items or services sold by said at least one retail establishment are most likely to appeal to consumers for a given time frame;
c) sending a recommendation to a representative of said specific retail establishment for a promotional event involving said key items or services.

### BRIEF DESCRIPTION OF THE DRAWINGS

A better understanding of the invention will be obtained by considering the detailed description below, with reference to the following drawings in which:

FIG. 1 is a block diagram of a system which may be used to practice the invention;

FIG. 2 is a flowchart illustrating the steps in a method according to one aspect of the invention;

FIG. 3 is a flowchart illustrating the steps in another method according to another aspect of the invention.

### DETAILED DESCRIPTION OF THE INVENTION

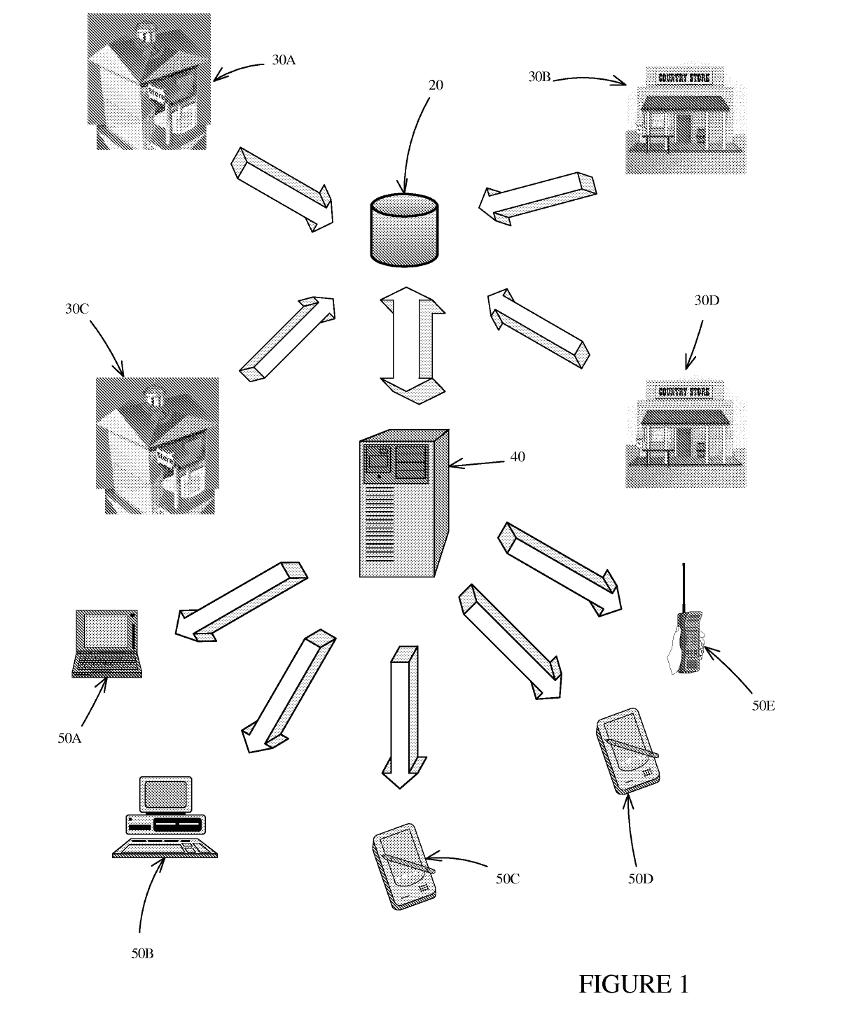

Referring to FIG. 1, a system on which the invention may be practiced is illustrated. The system 10 has a database 20 into which retail transactions for retail establishments 30A, 30B, 30C, 30D are stored. A data processing system 40 is in communication with the database 20. The data processing system 40 has the capability to process the retail transactions from the database and to derive data from them. The data processing system 40 also has the capability to communicate with users 50A, 50B, 50C, 50D, 50E.

The various retail establishments 30A-30D send their retail transactions to the database 20 for storage. The retail establishments may also do this for data warehousing purposes, for clearinghouse purposes, or to process their retail transactions using the data processing subsystem.

The operators of the data processing system 40 may thus offer a service to the various retail establishments 30A-30D to monitor their retail transactions relative to those of their competitors or relative to other businesses comparable to them. As an example, if retail establishment 30A is a coffee shop and retail establishments 30B, and 30C are comparable businesses (e.g. a coffee and cupcake shop and a small sandwich shop with a lot of coffee sales), the retail transactions for establishments 30B and 30C would be relevant to retail establishment 30A.

To determine how specific retail establishment 30A is doing relative to comparable businesses, a time frame must first be determined. This way, the data to be gathered from the database 20 is time limited. It should be noted that the time frame is preferably in the order of a few days so that the relative health of a retail establishment can be determined as a snapshot. However, other time frames are, of course, possible. Preferably, the time frame is that of the last few days before the request so that a specific retail establishment's current relative business can be determined.

Once the time frame has been determined, the retail transactions for that time frame are retrieved for both a specific retail establishment and the other establishments which are comparable to the specific retail establishment. Other retail establishments which would be comparable to a specific retail establishment would be establishments which would have similar products or services offered (and preferably prices as well) and which would be comparable in size in terms of yearly sales. As an example, it would not be reasonable to compare a small mom-and-pop coffee shop with a large fine dining establishment. Similarly, it would not be reasonable to compare the retail transactions for the same coffee shop with a higher end coffee shop such as a Starbucks™ location or a large Wal-Mart™ franchise.

It should be noted that the other retail establishments whose retail transactions are to be retrieved are, preferably, located in the same city if not the same vicinity as the specific retail establishment. While establishments which are in other locales or cities may have data that would be helpful in determining whether the specific retail establishment is doing well or not, data from co-located or same city establishments would be more helpful in determining consumer activity that is relevant to the specific retail establishment.

Once the retail transactions for the comparable retail establishments have been downloaded or retrieved from the database 20, these are then aggregated to remove the specific identities of the other retail establishments. The aggregated results from the retail transactions are then normalized to a per-store or per-location basis. After this is done, the results are then compared to the summed up retail transactions from the specific retail establishment.

It should be noted that the retail transactions from the other retail establishments may be used in a multitude of manners. In one implementation, the retail transactions are tallied up on a purely dollar basis and are then divided by the number of retail establishments involved. This will then give a per establishment dollar amount for the given time period which can be compared with the similar dollar amount of retail transactions for the specific retail establishment.

In another implementation, the retail transactions can be aggregated on a number of transactions per establishment basis. The retail transactions for the other retail establishments are aggregated and then the number of retail transactions for the time frame are divided by the number of retail establishments to give a number of transactions per establishment for the given time frame. This can then be compared with the number of retail transactions for the time period for the specific retail establishment. The number of retail transactions can provide an indication of how busy an establishment is.

The retail transactions may be aggregated using finer granularity. This can be done by aggregating not just the total number of transactions or the total dollar amount for the other establishments but the number of specific items sold during the given time frame across the various other establishments. As an example, the retail transactions may be analyzed to determine how many cheeseburgers were sold for the past 3 days across the various other establishments comparable to a specific restaurant specializing in burgers. Of course, as with the other implementations noted above, the retail transactions are aggregated and rendered anonymous so that the specific identities of the various other establishments are hidden from the specific retail establishment.

The comparison of the resulting data from the retail transactions for the other retail establishments with the data from the retail transactions from the specific retail establishment should preferably take into account a percentage range. Instead of directly determining whether the results from one set of data is higher or lower than the results from the other set of data, the comparison may determine whether one set of data is within a certain percentage of the other set of data. As an example, instead of generating an alert when the data from the retail transactions of the specific retail establishment shows lower business activity than the other retail establishments, the alert may be generated when the business activity is lower by a specific percentage. Thus, if coffee house A has a smaller number of retail transactions than the aggregated retail transactions from the other establishments (on a per store basis) but the coffee house A data is within 2.5% of the other data, then an alarm or an alert may not be generated. On the other hand, if the coffee house A data is lower by 5% or more than the other data, then the alarm or alert may be generated. The use of a percentage can take into account the idea that as long as the specific retail establishment is competitive with the other retail establishments, comparatively lower business activity is acceptable. Of course, the percentage may be user configurable.

As noted above, if the business activity of the specific retail establishment is less than those of comparable establishments, an alert may be initiated. Depending on the configuration of the system, the alert may cause any number of events to occur. In one embodiment, the alert may precipitate a notification to a representative of the specific retail establishment. The notification may be as simple as a notification that their business activity level is lower than those of surrounding comparable businesses. As noted above, the system can be in communication with a number of users 50A-50E. One of these users may be the representative from the specific retail establishment. On the other hand, the alert may trigger the system to recommend promotional events that would be designed to increase business activity for the specific retail establishment in a short period of time.

To recommend promotional events that are designed to increase business activity, the system 40 has to know what items and/or services are likely to increase that business activity. This can be done in a number of ways—the system may analyze the retail transactions of the specific retail establishment, the retail transactions of comparable establishments, or both.

If the system is to analyze the retail transactions of the specific retail establishment, the system first retrieves those retail transactions for the specific time period. In one implementation, the retail transactions for the past few days (perhaps as little as 2 or 3 days and as much as 5-15 days) are retrieved from the database. The system then determines which items/services account for the most retail transactions. This can be done either on a dollar basis (which items/services account for the bulk of the retail transactions) or on a transaction basis (which items/services account for the most number of retail transactions). Alternatively, the system may determine which items/services account for the most profit for the specific business establishment. In yet another implementation, the system analyzes the retail transactions using a formula which takes into account the various alternatives noted above.

In an alternative to either of the above, the system may analyze the retail transactions for both the specific retail establishment and the other retail establishments. For this alternative, the retail transactions for both the specific retail establishment and the other establishments are retrieved for the given time period. These retail transactions can then be aggregated and then analyzed per the above various methods.

Once the retail transactions have been analyzed, the system can then communicate with recommendations to the representative of the specific retail establishment. As an example, the system may have determined that, for a burger-oriented establishment, the bulk of its sales for the past 3 days may have been its cheese burger deluxe. The system may thus recommend that a promotional event featuring the cheese burger deluxe be launched. Or, as another example, the system may determine that comparable businesses to a coffee shop have had a majority of its retail transactions related to cafe mocha drinks. The system may thus recommend that the specific retail establishment launch a promotional event involving cafe mocha drinks.

Regarding the promotional event recommended by the system, the event may be a time limited and yet targeted event. The promotional event may involve coupons that users have to buy beforehand and which they can only redeem at the specific retail establishment. The offer of such coupons can be communicated to subscribers to an Internet-based service managed by the system. These subscribers can be the users in communication with the system as illustrated in FIG. 1.

In one embodiment, the coupons are offered directly to the subscribers by way of notifications. The notifications are sent by email, text message (perhaps using the SMS system), or any other relevant communications technology. The notifications can also be sent only to those subscribers who are in the vicinity of the specific retail establishments.

The coupons may also be a time-limited event. The coupons would need to be purchased by subscribers within a given time limit from the time the notification is sent, otherwise the offer expires. In yet a further embodiment, the coupons can only be redeemed at the specific retail establishment at specific time periods. As one example, a subscriber in Ottawa may be sent a notification that cake shop A (located in Ottawa) is offering a $10 cake for $8 but only if the subscriber buys the $8 coupon within one hour of the notification being sent (a countdown can be part of the notification). Also, in the example, the coupon can only be redeemed at cake shop A on a specific day, preferably within a day or so of the notification being sent. In this example and embodiment, the notification, the coupon, and the offer would all be designed to increase business activity for the specific retail establishment in as short or as little time as possible. Thus, the subscriber would be provided a small time window to purchase the coupon and a similarly small time window to redeem the coupon at the specific retail establishment.

As a further refinement of the above, the coupon offer may not just be a time-limited event but may also be a quantity limited event. For such an embodiment, only a limited number of coupons may be purchased by the subscribers. As an example, only 50 coupons may be purchased by all the subscribers and only one coupon per subscriber may be bought.

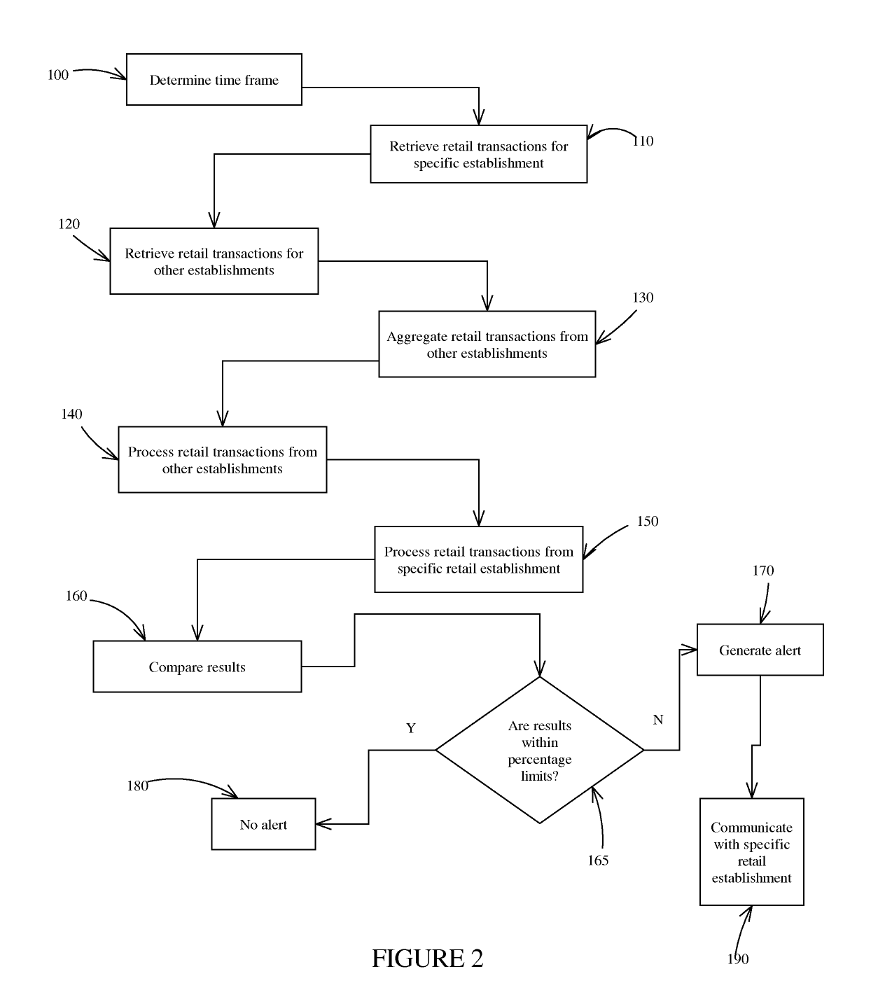

Referring to FIG. 2, a flowchart detailing the steps of one aspect of the invention is illustrated. This aspect of the invention involves determining the level of business activity for a specific retail establishment. Step 100 is that of determining a time frame for which the level of business activity for the specific retail establishment is to be found. Step 110 then retrieves the retail transactions for the specific retail establishment. Step 120 then retrieves the retail transactions for the other establishments comparable to the specific retail establishment. The retail transactions for the other establishments are then aggregated to remove the identities of the establishments (step 130). After the aggregation, the data for the other establishments are processed (step 140). Processing may involve determining the level of business activity for the other retail establishments on a total dollar basis, a number of transactions basis, or any other basis. Of course, the results are normalized on a per location basis. The data for the specific retail establishment is then processed in a manner similar to the data for the other establishments (step 150). The results from the two sets of data are then compared (step 160 and decision 165). If the results from the specific retail establishment is lower by more than a predetermined percentage than the results from the other establishments, an alarm or alert is triggered (step 170). If the results for the specific retail establishment is within acceptable limits (higher than the results from the other establishments or within the predetermined percentage), then an alarm or alert is not triggered (step 180). The alert can cause the system to communicate with a representative of the specific retail establishment (step 190).

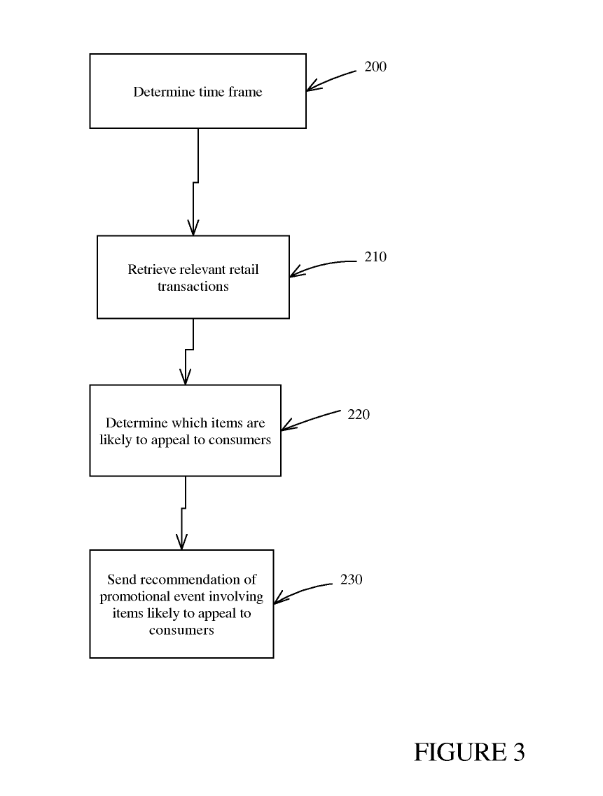

The alert noted above may launch another aspect of the invention—a method for recommending promotional events that are designed to increase business activity for the specific retail establishment. The steps in this method are illustrated in FIG. 3.

The steps illustrated in FIG. 3 begin with step 200, that of determining a time frame or time period for the analysis of the retail transaction data. Step 210 is that of retrieving the retail transactions for the relevant time period from the database. This involves retrieving either retail transactions from the specific retail establishment, the other comparable retail establishments, or both. The data to be retrieved would depend on whether the promotions are to be based on the sales from the specific retail establishment, the sales from the other comparable retail establishments, or both. As can be imagined, each alternative has its own merits and drawbacks.

Once the relevant data has been retrieved, the retail transactions are then analyzed to determine which products and/or services are most likely to appeal to consumers (step 220). This analysis may be based on which items make up the bulk of the transactions in terms of dollar value, number of transactions, or profit margin. Step 230 is then that of communicating with a representative of the specific retail establishment to recommend promotional events that involve those items determined in step 220.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for determining a level of business activity for a specific retail establishment, the method comprising:
a) determining a time frame for determining said level of business activity;
b) retrieving business transactions for said specific retail establishment from a database for said time frame;
c) determining other retail establishments which are in a similar type of business as said specific retail establishment;
d) retrieving business transactions for said other retail establishments from said database for said time frame;
e) determining a retail establishment total for said business transactions retrieved in step b);
f) determining an other business total for said business transactions retrieved in step d), said other business total being determined on a per retail establishment basis;
g) determining if said retail establishment total determined in step b) is higher or lower than said other business total determined in step f);
h) in the event said retail establishment total determined in step b) is lower than said other business total determined in step f), determining if said retail establishment total is within a predetermined percentage of said other business total;
i) in the event said retail establishment total is lower than said other business total and said retail establishment total is not within a predetermined percentage of said other business total, generating an alert to a user.

2. A method according to claim 1 wherein said alert causes an execution of a promotional method for generating promotions for increasing business for said retail establishment, said promotional method comprising:
j) retrieving data from said database relating to sales made by said specific retail establishment for a predetermined time period;
k) determining which key items or services sold by said specific retail establishment are most likely to appeal to consumers for a given time frame;
l) sending a recommendation to a representative of said specific retail establishment for a promotional event involving said key items or services.

3. A method according to claim 1 wherein said other retail establishments determined in step c) are other retail establishments in physical proximity to said specific retail establishment.

4. A method according to claim 1 wherein said other retail establishments determined in step c) are other retail establishments in the same city as said specific retail establishment.

5. A method according to claim 1 wherein said totals determined in steps e) and f) are determined on a dollar total basis.

6. A method according to claim 1 wherein said totals determined in steps e) and f) are determined on a number of transactions total basis.

7. A method according to claim 1 wherein said alert causes a message to be sent to a representative of said specific retail establishment.

8. A method according to claim 1 wherein said business transactions retrieved in steps b) and d) are retail sales.

9. A method according to claim 1 wherein said business transactions retrieved in steps b) and d) are retail sales for specific items.

10. A method according to claim 2 wherein said promotional method comprises:
m) in the event said representative approves of said recommendation, sending a notification to specific users of a time limited offer from said specific retail establishment involving at least one of said key items or services.

11. A method according to claim 10 wherein, to take advantage of said limited time offer, said specific users must purchase a coupon relating to said at least one of said key items or services within a predetermined first time frame and must redeem said coupon at said specific retail establishment within a predetermined second time frame.

12. A method according to claim 1 wherein said alert causes an execution of a promotional method for generating promotions for increasing business for said retail establishment, said promotional method comprising:
j) retrieving data from said database relating to sales made by said other retail establishments for a predetermined time period;
k) determining which key items or services sold by said other retail establishment are most likely to appeal to consumers for a given time frame;
l) sending a recommendation to a representative of said specific retail establishment for a promotional event involving said key items or services.

13. A method according to claim 12 wherein said promotional method comprises:
m) in the event said representative approves of said recommendation, sending a notification to specific users of a time limited offer from said specific retail establishment involving at least one of said key items or services.

14. A method according to claim 13 wherein, to take advantage of said limited time offer, said specific users must purchase a coupon relating to said at least one of said key items or services within a predetermined first time frame and must redeem said coupon at said specific retail establishment within a predetermined second time frame.

15. A method for determining promotional offers for increasing business activity for a specific retail establishment, the method comprising:
a) retrieving data from a database relating to sales made by said specific retail establishment for a predetermined time period;
b) determining which key items or services sold by said specific retail establishment are most likely to appeal to consumers for a given time frame;
c) sending a recommendation to a representative of said specific retail establishment for a promotional event involving said key items or services.

16. A method according to claim 15 wherein said method comprises:
d) in the event said representative approves of said recommendation, sending a notification to specific users of a time limited offer from said specific retail establishment involving at least one of said key items or services.

17. A method according to claim 16 wherein, to take advantage of said limited time offer, said specific users must purchase a coupon relating to said at least one of said key items or services within a predetermined first time frame and must redeem said coupon at said specific retail establishment within a predetermined second time frame.

18. A method for determining promotional offers for increasing business activity for a specific retail establishment, the method comprising:
a) retrieving data from said database relating to sales made by said other retail establishments for a predetermined time period;
b) determining which key items or services sold by said other retail establishment are most likely to appeal to consumers for a given time frame;
c) sending a recommendation to a representative of said specific retail establishment for a promotional event involving said key items or services.

19. A method according to claim 18 wherein said method comprises:
d) in the event said representative approves of said recommendation, sending a notification to specific users of a time limited offer from said specific retail establishment involving at least one of said key items or services.

20. A method according to claim 19 wherein, to take advantage of said limited time offer, said specific users must purchase a coupon relating to said at least one of said key items or services within a predetermined first time frame and must redeem said coupon at said specific retail establishment within a predetermined second time frame.

21. A method for determining promotional offers for increasing business activity for a specific retail establishment, the method comprising:
a) retrieving data from said database relating to sales made by at least one retail establishment for a predetermined time period;
b) determining which key items or services sold by said at least one retail establishment are most likely to appeal to consumers for a given time frame;
c) sending a recommendation to a representative of said specific retail establishment for a promotional event involving said key items or services.

22. A method according to claim 21 wherein said at least one retail establishment includes said specific retail establishment.

23. A method according to claim 22 wherein said at least one retail establishment includes other retail establishments.

24. A method according to claim 23 wherein said other retail establishments comprise retail establishments comparable to said specific retail establishment.
